(19) United States
(12) Patent Application Publication
(10) Pub. No.: US 2026/0347535 A1
(43) Pub. Date: Nov. 5, 2026

(54) Ambient Temperature Initiated, Multistage Cured Polymeric Compositions

(71) Applicant: Zephyros, Inc., Romeo, MI (US)

(72) Inventors: Michael Czaplicki, Romeo, MI (US); Vincent Duclos, Romeo, MI (US); Vincent Goldman, Romeo, MI (US); Donald Paquet, Romeo, MI (US); Norman Rawls, Romeo, MI (US)

(21) Appl. No.: 19/482,069

(22) PCT Filed: May 23, 2024
(86) PCT No.: PCT/US2024/030848

§ 371 Date: Nov. 6, 2025

Related U.S. Application Data
(60) Provisional application No. 63/468,314, filed on May 23, 2023.

(51) Int. Cl. C08G 59/14; C08K 7/22; C08L 63/04; C09K 5/14

(52) U.S. Cl. CPC C08G 59/1422; C08K 7/22; C08L 63/04; C09K 5/14; C08L 2207/53

(57) ABSTRACT

A polymeric composition comprising a part A and a part B adapted to react with part A, wherein upon contacting part A and part B, heat is generated from a first exothermic reaction which increases the composition temperature to a temperature sufficiently high to cause a second exothermic reaction.

### CLAIM OF PRIORITY

This application claims the benefit of the filing date of U.S. Provisional Application No. 63/468,314, filed May 23, 2023, the contents of that application being hereby incorporated by reference herein in its entirety and for all purposes.

### TECHNICAL FIELD

The present teachings relate generally to polymeric compositions suitable for forming room temperature cured products that meet performance criteria with little to no external influence. In one embodiment, the teachings are directed to an ambient temperature initiated, multistage reaction cured, high glass transition (Tg) thermoset polymer that cures without the use of any external heating mechanism. The invention is set out in the appended claims.

### BACKGROUND

Polymeric compositions often perform well at super-ambient (temperature, pressure, chemical environment) conditions. As the in-use application environment deviates more from ambient, there is a continual need for improved performance of polymeric systems. This often results in super-ambient external conditions in which the polymeric composition is reacted and cured to achieve required performance targets. For example, it is well known that heat-cured epoxy thermosets can have much higher glass transition temperatures (Tg) as well as tensile moduli and other physical properties as compared to ambient temperature cured epoxy thermosets.

There is also the competing desire to minimize these external curing conditions which have economic, productivity, and environmental costs. Unfortunately, single stage acceleration of curing, starting from ambient condition, often results in both extremely short working times at ambient conditions as well as potentially uncontrolled reactions leading to deleterious product performance.

Elevated glass transition polymeric compositions are one example of an improved performance target. High Tg polymeric compositions find utility in applications such as tooling boards, circuit boards, and parts for aerospace, automotive, building construction, and marine industries. High Tg compositions allow for utility under high temperature service conditions by maintaining their physical properties at elevated temperatures. Other performance targets can be tensile modulus, compressive modulus, and flexural modulus, among others.

As one specific example, high Tg polymeric compositions used to create tooling boards are typically made from various polymeric materials that are compounded and or mixed, then heated in an oven to temperatures that allow for high Tg compositions to be achieved. Typically, it is necessary to do this to achieve the desired glass transition temperature. These oven temperatures are often at or above the desired glass transition temperature. Additional salient properties of tooling boards can include coefficient of thermal expansion, hardness, tensile strength, flexural strength, compressive strength, strain to failure, density, and fracture toughness.

High Tg polymeric compositions are commonly made from vinyl ester, acrylic, urethane, phenolic, or epoxy resins systems. Certain resin systems can provide cured products with glass transition temperatures>100 °C, which can be used in applications requiring elevated temperature performance.

The existing process for making high Tg compositions involves mixing various constituents together, pouring the mixture into molds, waiting up to a day while the reaction mixture partially cures then heating the mixture in ovens for some time until full cure is achieved. Staged curing schedules are also common to avoid warping and cracking during the curing process. This process sequence can take up to a week. It requires the use of curing ovens which are a capital expense, take up valuable manufacturing space, and incur significant operating expense. As a result, the amount of product that can be produced per unit time is limited, and as such, creates a bottleneck in manufacturing. Also, these factors contribute significantly to the environmental footprint of a high Tg composition.

Fundamentally, achieving high Tg polymeric compositions involves mixing and then heating curable materials at above or near the Tg that is theoretically feasible for those materials.

The process of making high Tg composites also requires reactant mixtures to have a reasonable working time sufficient for mixing and dispensing into molds or trays. These molds can be very large, exceeding 100 liters in material volume with a desire for greater volumes, if possible, further emphasizing the requirement for reasonable working time.

High Tg polymeric compositions should also be free of char (burnt and/or blackened material) which can be indicative of degraded properties. In the worst case, curing compositions may auto ignite. In addition, high Tg polymeric compositions should be fully cured to reduce waste and ensure consistent mechanical properties throughout their entire volume and produce long term product stability.

It is therefore desirable to manufacture high Tg polymeric compositions with little to no external heating. This would greatly reduce the capital required, manufacturing costs, and the environmental footprint of the produced compositions. Unfortunately, accelerating the typical curing reactions to cure at ambient condition in a single stage process typically leads to unacceptably short working times as well as potentially charred and consequently degraded compositions.

As Tg represents one aspect of polymeric compositions, the present teachings overcome current constraints encountered in making high Tg compositions by providing compositions that have reasonable working times, initiate cure at or near ambient conditions and require no external heating while producing materials with a high Tg, no char, and full cure.

### SUMMARY OF THE INVENTION

The teachings herein are directed to a polymeric composition comprising a part A, and a part B adapted to react with part A, wherein upon contacting part A and part B, heat is generated from a first exothermic reaction which increases the composition temperature to a temperature sufficiently high to cause a second exothermic reaction.

The first exothermic reaction may be initiated at temperatures less than 40 °C.

A peak temperature of the composition may be greater than 100 °C. The composition may have a glass transition temperature (Tg) of about 100 °C or greater.

The composition may include a reinforcing component.

The composition may include a thermally conductive material.

The composition may include a component comprising hollow spheres.

Part A, part B, or both may include one or more thermally induced phase changing materials.

Part A, part B, or both may include a physical blowing agent. Part A, part B, or both may include a chemical blowing agent.

The composition may include one or more toughening agents. The one or more toughening agents may include one or more core-shell particulate toughening agents.

The composition may include one or more rheological control agents.

Part A may include one or more epoxy resins.

The composition may include one or more carboxylic acid cyclic anhydrides.

Part B may include one or more acidic phosphorous components.

Part A, part B, or both may include one or more catalysts for causing a reaction between an epoxy and a carboxylic acid cyclic anhydride.

The composition may include one or more (meth)acrylate monomers and/or one or more (meth)acrylic functional resins.

Part A, part B, or both may include one or more peroxides. Part A, part B, or both may include one or more peroxide decomposition accelerators.

Part A, part B, or both may include one or more free-radical inhibitors.

Part A, part B, or both may include one or more isocyanate resins.

Part A, part B, or both include one or more resins that are reactive with isocyanates.

Part A, part B, or both may include one or more amine resins.

Part A, part B, or both may include one or more latent catalysts.

Part A, part B, or both may include one or more ring-strained components adapted for exothermic ring-opening reactions.

Part A, part B, or both may include one or more components selected from epoxy resins, carboxylic cyclic anhydrides, cyclic carbonates, cyclic lactones, dicyclopentadiene, benzoxazines, or combinations thereof. The composition may comprise one or more materials that react with epoxy resins, carboxylic cyclic anhydrides, cyclic carbonates, cyclic lactones, dicyclopentadiene, benzoxazines, or combinations thereof. Part A, part B, or both may include one or more catalysts that catalyze a reaction with epoxy resins, carboxylic cyclic anhydrides, cyclic carbonates, cyclic lactones, dicyclopentadiene, benzoxazines, or combinations thereof.

Part A, part B, or both may include (i) a silica rheology agent, preferably a fumed silica rheology agent or a hydrophilic fumed silica rheology agent or both; and/or (ii) an aliphatic amine, preferably modified for curing epoxy; and/or (iii) a methyl tetrahydrophthalic anhydride; and/or (iv) a triglycidylized para-aminophenol; and/or (v) a tetra glycidyl methylene dianiline resin; and/or (vi) a dispersion of 50% wt benzoyl peroxide free radical initiator; and/or (vii) boron nitride, preferably being a thermoconducting particulate filler; and/or (viii) a wetting agent and/or dispersing agent; and/or (ix) a tertiary amine catalyst; and/or (x) a phosphonium ionic liquid epoxy curing agent; and/or (xi) a micronized form of dicyandiamide; and/or (xii) a liquid bisphenol A diglycidyl ether; independently of one another preferably in an amount of at least 5 wt.-% or at least 15 wt.-% or at least 35 wt.-% or at least 55 wt.-% or at least 75 wt.-% or at least 95 wt.-%, and/or at most 95 wt.-% or at most 75 wt.-% or at most 55 wt.-% or at most 35 wt.-% or at most 15 wt.-% or at most 5 wt.-%, in either case based on the total weight of the polymeric composition or part A or part B.

Part A, part B, or both may include: (i) an epoxy resin derived from o-cresol novalac; and/or (ii) a liquid diglycidyl ether of Bisphenol F resin; and/or (iii) an epoxy resin derived from phenol novalac; and/or (iv) a tetra glycidyl methylene dianiline resin; and/or (v) a sorbitol polyglycidyl ether; and/or (vi) a dry powder of thermally expandable microspheres; and/or (vii) Ferrocene; and/or (viii) a nanoclay additive; and/or (ix) a HEMA phosphate; and/or (x) a calcium carbonate particulate; and/or (xi) 4-Hydroxy TEMPO which is a 4-hydroxy-2,2,6,6-tetramethylpiperidin-1-oxyl free radical polymerization inhibitor; and/or (xii) IBOMA which is a isobornyl methacrylate; and/or (xiii) soda lime glass microspheres; and/or (xiv) a mixture of core-shell particles dispersed in liquid bisphenol F and diglycidyl ether; and/or (xv) a liquid diglycidyl ether of bisphenol A; and/or (xvi) a tert-butyl peroxybenzoate free radical initiator; independently of one another preferably in an amount of at least 5 wt.-% or at least 15 wt.-% or at least 35 wt.-% or at least 55 wt.-% or at least 75 wt.-% or at least 95 wt.-%, and/or at most 95 wt.-% or at most 75 wt.-% or at most 55 wt.-% or at most 35 wt.-% or at most 15 wt.-% or at most 5 wt.-%, in either case based on the total weight of the polymeric composition or part A or part B.

Part A, part B, or both may include: (i) a 40% active dispersion of 1,1-di(tert-butylperoxy)-3,3,5-trimethylcyclohexane crosslinking peroxide on calcium carbonate; and/or (ii) Methacrylic acid; and/or (iii) tris(2-hydroxyethyl) isocyanurate, triacrylate; and/or (iv) Nadic Methyl anhydride (NMA) which is a cyclic anhydride; and/or (v) an expandable graphite particulate; and/or (vi) PE13, which is an acidic phosphate ester derived from the stoichiometric (phosphorous/epoxy) reaction of Eriysis GE 13 (phenyl glycidyl ether) and 85% wt. aqueous Phosphoric acid; and/or (vii) PE20, which is an acidic phosphate ester derived from the stoichiometric (phosphorous/epoxy) reaction of Eriysis GE 20 (neopentyl glycol diglycidyl ether) and 85% wt. aqueous Phosphoric acid; and/or (viii) PE30, which is an acidic phosphate ester derived from the stoichiometric (phosphorous/epoxy) reaction of Eriysis GE 30 (trimetholyl propane triglycidyl ether) and 85% wt. aqueous Phosphoric acid; and/or (ix) Phosphoric acid (H3PO4), preferably 85% wt. aqueous, food grade; and/or (x) an urea accelerator; and/or (xi) a dimer fatty acid; and/or (xii) hollow glass microspheres; and/or (xiii) a spherical aluminum powder; and/or (xiv) 3,4-Epoxycyclohexylmethyl-3,4-epoxycyclohexanecarboxylate; and/or (xv) an air-atomized aluminum powder; independently of one another preferably in an amount of at least 5 wt.-% or at least 15 wt.-% or at least 35 wt.-% or at least 55 wt.-% or at least 75 wt.-% or at least 95 wt.-%, and/or at most 95 wt.-% or at most 75 wt.-% or at most 55 wt.-% or at most 35 wt.-% or at most 15 wt.-% or at most 5 wt.-%, in either case based on the total weight of the polymeric composition or part A or part B.

The composition may be suitable for and/or configured for tooling board applications.

The second exothermic reaction may produce physical properties that are not achievable by the first exothermic reaction alone.

The teachings herein are further directed to a method for manufacturing a polymeric composition of any of the preceding claims comprising: (i) providing a part A in accordance with the teachings herein; (ii) providing a part B in accordance with the teachings herein and being adapted to react with part A; and (iii) contacting part A and part B. Upon contacting part A and part B, heat is generated from a first exothermic reaction which increases the composition temperature to a temperature sufficiently high to cause a second exothermic reaction.

The teachings herein are further directed to use of the compositions in accordance with the present teachings for tooling board applications.

The teachings herein are also directed to a polymeric composition comprising: a part A comprising at least 20% by weight of a first epoxy resin; and a part B comprising an acidic component adapted to react with part A. Upon contacting part A and part B, heat is generated from a first exothermic reaction which increases the composition temperature to a temperature sufficiently high to cause a second exothermic reaction.

The acidic component may be phosphoric acid.

The acidic component may be present in amount of at least 7% of the part B.

The acidic component may be methacrylic acid.

The part B may include a phosphate ester.

The part A may include at least a first epoxy and a second epoxy; and optionally a third epoxy.

### BRIEF DESCRIPTION OF THE DRAWINGS

FIG. 1 is a graph depicting the temperature as a function of time produced by formulation listed in Table 1D and demonstrates an epoxy-acidic phosphorous/epoxy-anhydride reaction system.

FIG. 2 shows the reduced charring in formulation 53-14 which contains aluminum powder.

FIG. 3 shows a graph depicting the increase in temperature over time of an exemplary composition in accordance with the present teachings.

FIG. 4 shows a graph depicting the increase in temperature over time of an exemplary composition in accordance with the present teachings.

FIG. 5 shows composites formed with and without a phosphonium ionic liquid catalyst.

FIG. 6 shows the temperature as a function of time of an exemplary composition in accordance with the present teachings.

### DETAILED DESCRIPTION

The explanations and illustrations presented herein are intended to acquaint others skilled in the art with the present teachings, its principles, and its practical application. The specific embodiments of the present teachings as set forth are not intended as being exhaustive or limiting of the present teachings. The scope of the present teachings should be determined with reference to the appended claims, along with the full scope of equivalents to which such claims are entitled. The disclosures of all articles and references, including patent applications and publications, are incorporated by reference for all purposes. Other combinations are also possible as will be gleaned from the following claims, which are also hereby incorporated by reference into this written description. Percentages herein refer to weight percent, unless otherwise indicated.

The teachings herein are directed to a composition adapted for a multi-stage cure, such that components of the composition initiate a cure at or near ambient conditions (e.g., less than 40 °C) and proceeds to full cure with minimal external influence. The compositions herein may be such that multi-stage cure enables the manufacture of high Tg polymeric compositions. The first stage of curing creates an initial reaction exotherm by which the resulting temperature increase then activates a second stage of curing. When a sufficiently high temperature has been reached, the second stage of curing further drives the exotherm higher to produce a high Tg polymeric composition.

In addition to high Tg, the multi-stage cure systems as disclosed herein may be utilized to improve a polymeric material's strain to failure, provide higher fracture toughness, improved stiffness, improved solvent resistance, modified decomposition temperature, or any combination of those improvements.

Incorporation of two or more distinct curing reactions also enables a reduction of the initial cure to less than what is necessary to cure the product fully. This assists in moderating the initial exotherm. The subsequent curing phases do not significantly participate in earlier curing phases until the necessary elevated activation temperature has been reached. The multi-stage exothermic cure mechanism approach allows for the potential of a longer working time while still allowing the system to reach full cure as the reaction occurs in multiple steps over several temperature ranges.

The present teachings contemplate combining ambient temperature exothermic reaction systems with typical oven-curing exothermic reaction systems in varying amounts in which the ambient temperature system provides sufficient heat to activate the oven-curing systems without the need for an oven. The present teachings contemplate a plurality of exothermic reactions to provide an in-situ multi-stage cure commencing at or near ambient temperature. Ambient temperature reaction systems include ring opening of strained-ring groups, such as epoxy, cyclic lactone, cyclic carbonate, cyclic anhydride, dicyclopentadiene, benzoxazine, addition polymerization of vinyl ester and/or (meth)acrylate resins, and reactions involving isocyanate resins.

Ambient temperature-initiated ring opening of epoxy resins can occur with acidic phosphorous or sulfonic acid groups in the absence of any catalysis. Other ring opening epoxy resin reactions such as epoxy-thiol, epoxy-phenol, epoxy-hydroxy, epoxy-amine, epoxy-carboxylic acid require catalysis to provide sufficient reaction at ambient temperature. Epoxy homopolymerization is variation of epoxy-hydroxy and another exothermic reaction that can be initiated at ambient temperature with sufficient catalysis.

Ambient temperature-initiated addition polymerization of vinyl ester and/or (meth)acrylate resins with peroxides in combination with suitable peroxide decomposition accelerators are well known in the art. Non-limiting examples include tertiary aromatic amines (N,N-Dimethyaniline, N,N-Dimethyl-p-toluidine, N,N-Dimethyl-o-toluidine, N,N-Diethyl-p-toluidine, N-(2-Hydroxyethyl), N-methyl-p-toluidine), transition metals, transition metal carboxylates (cobalt 2-ethylhexanoate, copper acetylacetonate, copper naphthanate), metallocenes (ferrocene), 1-Acetyl, 2-phenylhydrazine, and sulfonyl chlorides (tosyl chloride, mesyl chloride, chlorosulphonated polyethylene).

Cyclic carbonates react at room temperature with primary amines.

Isocyanates react with active hydrogen containing materials (primary amines, secondary amines, polyols, thiols) as well as with themselves (trimerization).

Oven-curing systems may incorporate ambient temperature reaction systems as well as reactions involving cyclic anhydrides and benzoxazines. Utilization of reaction systems at oven curing conditions may require different catalysts/accelerators or complete elimination of certain catalysts/accelerators. Curatives and or catalysts that physically change (melt, dissolve) at elevated temperatures or chemically change (thermally reversible reactions) can be used. For example, latent curatives, such as dicyandiamide curative in epoxy-amine reactions are possible for the elevated temperature curing reaction. Blocked isocyanates are another example of reaction systems that can be used at elevated temperatures. Latent accelerators such as ureas, known in the art of epoxy-amine reaction systems are included. Blocked catalysts, such as acid-blocked tertiary amines are also considered.

The polymeric composition can also include additional ingredients in the mixture. Reinforcing components, fillers, wetting agents, rheology control agents, reinforcing fibers, thermoplastic polymers, flame retardants, pigments, and toughening agents such as core-shell particles, and foaming agents can also be part of the mixture. As potential non-limiting examples, additives can be used to alter the thermal conductivity and heat capacity of the composition; also, additives to alter the cured density (hollow particles, thermal/chemical foaming agents) are possible. Additional additives are possible to facilitate the machinability of the cured composition.

Thermal management fillers are useful in altering the heat capacity and thermal conductivity of the composition thereby altering the effect of the reaction exotherm. Suitable fillers for heat management include aluminum powder, boron nitride, graphite, graphene, aluminum trihydrate, iron powder, iron oxide, powdered polymers, and alumina.

Suitable components for reducing density and aiding in machinability in the case of tooling boards include glass microspheres (3M K15, K20, for example). The low isotactic crush strength, typically thin walled of preferred glass microspheres enables them to break easily when being cut for instance by a CNC router. This results in quicker cutting times and less wear on CNC cutting components. Hollow particles also permit adjustment of the thermal conductivity and thermal heat capacity and provide a component that consumes volume but does not add reactive functionality can be used to modify the temperature profile.

Physical blowing agents such as expandable microspheres (Expancel from Nouryon for example) may also be included to reduce the density of formed materials, although chemical blowing agents can be envisioned as well.

One or more thixotropes may be included to help prevent settling of or floating of fillers in the case of formulations that cannot be agitated prior to mixing include for instance, fumed silica, Aerosil® R 208, or mixed mineral thixotropies such as Garamite 1958, or combinations thereof.

### EXAMPLES

The following examples demonstrate compatible exothermic reaction chemistries that can initiate cure at or near ambient temperature and produce cured polymeric compositions with elevated Tg.

Aerosil R-208 is a treated fumed silica rheology agent available from Evonik.

Aerosil 200 is a hydrophilic fumed silica rheology agent available from Evonik.

Ancamine® 1644 is a modified aliphatic amine used to cure epoxy resins available from Evonik.

Aradur® HY-918 is methyl tetrahydrophthalic anhydride available from Huntsman.

Araldite® MY 0510 is a triglycidylized para-aminophenol available from Huntsman.

Araldite MY-721 is a tetra glycidyl methylene dianiline resin available from Huntsman.

Benox® B-50 is a dispersion of 50% wt benzoyl peroxide free radical initiator from United Initiators.

Boron nitride is a thermoconducting particulate filler available from 3M.

Byk® W 996 is a wetting and dispersing agent available from Byk.

Cardolite NT 1300 is a tertiary amine catalyst available from Cardolite.

Cyphos IL 169 is a phosphonium ionic liquid epoxy curing agent available from Solvay.

Dicyanex® 1200 is a micronized form of dicyandiamide available from Evonik.

Epokukdo YD-128 is a liquid bisphenol A diglycidyl ether available from Kukdo Chemical Company.

Epokukdo YDCN-500 80P is an epoxy resin derived from o-cresol novalac available from Kukdo Chemical Company.

Epokukdo YDF-170, is a liquid diglycidyl ether of Bisphenol F resin available from Kukdo Chemical Company.

Epokukdo YDPN 631 is an epoxy resin derived from phenol novalac available from Kukdo Chemical Company.

Epotec® YDM 441 is a tetra glycidyl methylene dianiline resin available from Aditya Birla.

Erisys® GE-60 is a sorbitol polyglycidyl ether available from Huntsman.

Expancel® 951 DU 120 is a dry powder of thermally expandable microspheres available from Nouryon.

Ferrocene is an organometallic compound available from Millipore Sigma.

Garamite 1958 is a treated nanoclay additive available from BYK.

HEMA phosphate is Naxonac® HP 1000 HEMA phosphate available from Nease.

Hubercarb® Q2 is calcium carbonate particulate available from Huber Engineered Materials.

4-Hydroxy TEMPO is 4-hydroxy-2,2,6,6-tetramethylpiperidin-1-oxyl free radical polymerization inhibitor available from Millipore Sigma.

IBOMA is isobornyl methacrylate available as Sipomer® IBOMA-HP from Solvay.

K20 are soda lime glass microspheres available from 3M.

K15 are soda lime glass microspheres available from 3M.

Kane Ace™ MX-267 is a mixture core-shell particles dispersed in liquid bisphenol F, diglycidyl ether, available from Kaneka.

KDS 8805 is a liquid diglycidyl ether of bisphenol A available from Kukdo Chemical Company.

Luperox P is tert-butyl peroxybenzoate free radical initiator available from Arkema.

Luperox 231XL 40 is 40% active dispersion of 1,1-di(tert-butylperoxy)-3,3,5-trimethylcyclohexane crosslinking peroxide on calcium carbonate available from Arkema.

Methacrylic acid is available from Millipore Sigma.

Miramer M370 is tris(2-hydroxyethyl) isocyanurate, triacrylate available from Miwon.

Nadic Methyl anhydride (NMA) is a cyclic anhydride available from Dixie Chemical.

Nyagraph 35 is an expandable graphite particulate available from Nyacol Nano Technologies Inc.

PE13, an acidic phosphate ester derived from the stoichiometric (phosphorous/epoxy) reaction of Eriysis GE 13 (phenyl glycidyl ether, available from Huntsman) and 85% wt. aqueous Phosphoric acid.

PE20, an acidic phosphate ester derived from the stoichiometric (phosphorous/epoxy) reaction of Eriysis GE 20 (neopentyl glycol diglycidyl ether, available from Huntsman) and 85% wt. aqueous Phosphoric acid.

PE30, an acidic phosphate ester derived from the stoichiometric (phosphorous/epoxy) reaction of Eriysis GE 30 (trimetholyl propane triglycidyl ether, available from Huntsman) and 85% wt. aqueous Phosphoric acid.

Phosphoric acid (H3PO4) 85% wt. aqueous, food grade available from Innophos.

SP-AD0052, urea accelerator available from Springfield Industries.

Pripol™ 1013 is a dimer fatty acid available from Cargill.

Q-Cel® 7023S are hollow glass microspheres available from Potters Industries.

S60HS are hollow glass microspheres available from 3M™.

SP75-100 is a spherical aluminum powder available from Toyal America

Syna Epoxy 21 is 3,4-Epoxycyclohexylmethyl-3,4-epoxycyclohexanecarboxylate available from Synasia.

Toyal 101 is an air-atomized aluminum powder available from Toyal America.

### Examples 1B-H—Epoxy Acidic Phosphorous/Epoxy—Acid/Anhydride System

In Example 1 the ambient temperature reaction system including epoxy and acidic phosphorous groups is combined with a typically oven cured epoxy-cyclic anhydride reaction system. Acidic phosphorous materials are selected from phosphoric acid, polyphosphoric acid, phosphonic acids, acidic phosphate esters, as well as materials with a plurality of acidic phosphorous groups.

### Example 1B

Formulations in Example 1B demonstrate how a second reaction can be utilized to control the initial curing stage and hence provide increased open time.

Formulations in Example 1B are prepared by mixing the respective A and Part Bs in a dual asymmetric centrifuge mixer (SpeedMixer® by FlackTek) speed mixer followed by mixing A and B together in a speed mixer for 15 seconds at 3500 rpm.

Component amounts in the formulation are given in weight percentages in Table 1B along with the acid to epoxy stoichiometry, and whether the formulation is liquid or solid when removing from the mixer. This is assessed by slightly shaking the mixture and recording the time when no movement is observed. If the resulting mixture is solid immediately after removing from the mixer it is not a viable solution as the material requires reasonable open time or working time (the time needed to maintain flow as mixed material is being dispensed). The use of an acid anhydride in the Part B such as nadic methyl anhydride (NMA) may provide longer open times at the same total acid level (as measured by acid to epoxy stoichiometry).

Formulations 5, 7, 8 and 9 (shown at Table 1B) illustrate longer open times with the use of NMA at the same stoichiometry. Formulation 5 solidifies almost instantly whereas formulation 7 is still liquid after 10 minutes. The presence of NMA dilutes the phosphoric acid and does not significantly react at ambient temperature. By having at least one additional reaction, full cure is not required of the ambient temperature reaction leading to longer working times.

TABLE 1B

| | 5 | 7 | 9 | 8 |
|---|---|---|---|---|
| Part A | | | | |
| 40% YDCN-500 | 83.33 | 78.40 | 86.50 | 82.30 |
| 80P inYDF-170 | | | | |
| Araldite MY 721 | 3.13 | 2.94 | 3.20 | 3.08 |
| Part B | | | | |
| Phosphoric acid | 13.54 | 9.30 | 10.30 | 7.30 |
| (85%) | | | | |
| NMA | 0 | 9.30 | 0 | 7.30 |
| Total | 100.00 | 100.00 | 100.00 | 100.00 |
| Liq/Solid Time | Solid | Liquid/>10 | Liquid/10 | Liquid/>60 |
| (minutes) | | | | |
| Acid/Epoxy | 0.85 | 0.86 | 0.63 | 0.63 |

### Example 1C

Example 1C demonstrates the effect of incorporating buffering agents into the acid curing composition as a strategy to control the peak reaction exotherm.

The formulations in this example are mixed, filled into cartridges, conditioned to 55 °C and dispensed into 400 ml HDPE molds.

When incorporated into the curative part B, basic materials like calcium carbonate may act as buffering agents and reduce the exothermic temperature of the reaction by buffering the curative prior to mixing with the epoxy resin (part A).

Component amounts in the example compositions are given as parts by weight in Table 1C below, along with their associated peak temperatures. Sample 53-9 without any calcium carbonate (Q2) shows a much higher peak temperature than sample 53-7 which includes the calcium carbonate.

TABLE 1C

| | 53-7 | 53-9 |
|---|---|---|
| Part A | | |
| YDCN 500-80P | 20.24 | 20.32 |
| YDF 170 | 30.36 | 30.48 |
| YDM 441 | 12.15 | 12.20 |
| GE 60 | 9.45 | 9.49 |
| S60H | 4.00 | 4.02 |
| Part B | | |
| Phosphoric Acid (85%) | 10.80 | 10.84 |
| NMA | 12.00 | 12.05 |
| Q2 | 0.40 | 0.00 |
| S60HS | 0.60 | 0.60 |
| Total | 100.00 | 100.00 |
| Peak temperature (°F) | 380 | 465 |

### Example 1D

The formulation in Example 1D demonstrates how dual cure compositions can have sufficient open time and still generate sufficiently high temperatures needed to produce a high Tg material.

The formulation shown below at Table 1D is prepared by filling parts A and B into cartridges and dispensing with static mixers into a square high density polyethylene mold. The total cartridge volume is 400 ml. The mix ratio is 4 parts epoxy part A to 1 part acid/anhydride part B. The cartridges are heated to 50 °C before dispensing. The dimensions of the resulting composite are roughly 11 cm×9 cm×4 cm. After dispensing the material, a thermocouple is inserted approximately in the center of the mold.

TABLE 1D

| Material | Amount |
|---|---|
| Part A | |
| YDF-170 | 35.04 |
| YDCN-500 80P | 16.96 |
| Cyphos IL 169 | 1.28 |
| K15 microspheres | 0.70 |
| Toyal 101 | 19.10 |
| YDM 441 | 10.51 |
| Aerosil R-208 | 0.34 |
| Part B | |
| NMA | 6.49 |
| Phosphoric Acid (85%) | 8.35 |
| K15 microspheres | 0.93 |
| R-208 | 0.35 |
| Total | 100.00 |

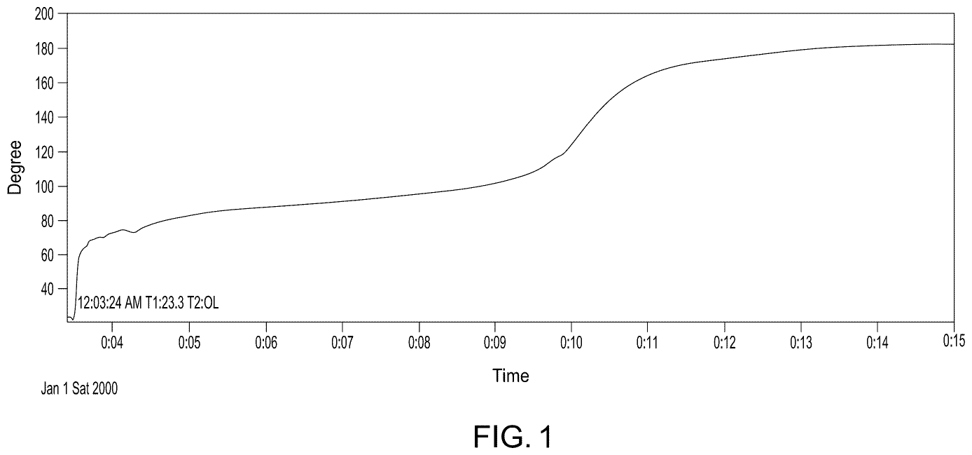

FIG. 1 shows the temperature as a function of time for the formulation in Table 1D. As shown in FIG. 1, the exotherm from the epoxy-acidic phosphorous reaction is sufficient to heat the mixture to a point at which the epoxy-anhydride reaction starts and further increases the temperature.

### Example 1E

Formulations in this example (see Table 1E below) are prepared as those in Example 1D.

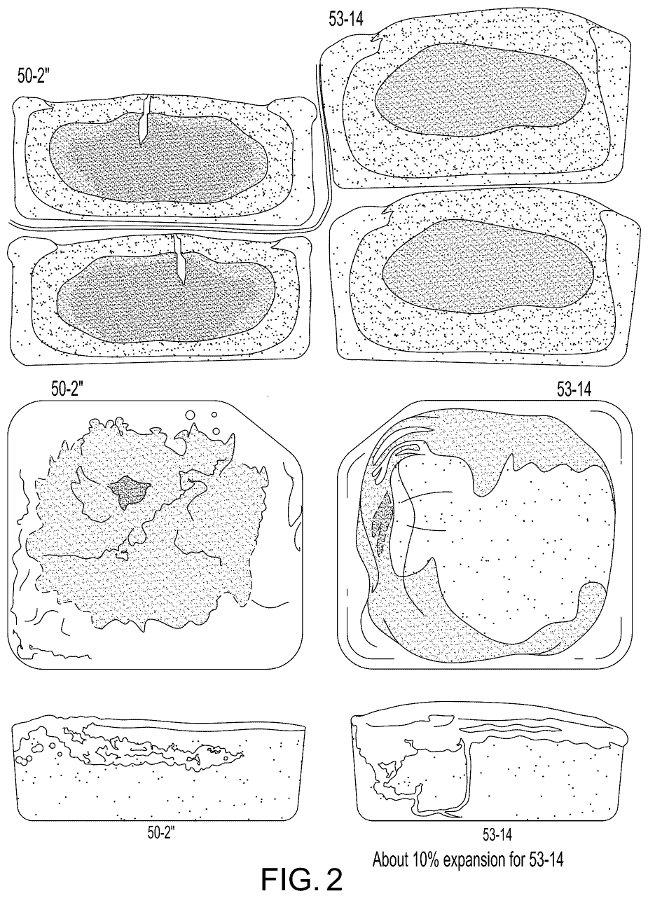

Incorporation of aluminum powder (for example Toyal grade 101), at levels of from about 5% up to about 20% by weight reduces char formation. Aluminum has a high thermal conductivity which facilitates heat transfer of the heat generated by the reaction throughout the cast object. FIG. 2 visually demonstrates the reduced charring in formulation 53-14 which contains aluminum powder. Both formulations shown at Table 1E below exotherm in the center to the same temperature. The formulation without aluminum (50-2″), is soft and waxy on the edges. This is evidence of lack of cure because of insufficiently high temperatures at the edges. Without being bound by theory, some foaming is also realized for the aluminum containing formulation (43-14) presumably due to the liberation of hydrogen gas because of the reaction between aluminum, phosphoric acid, and water.

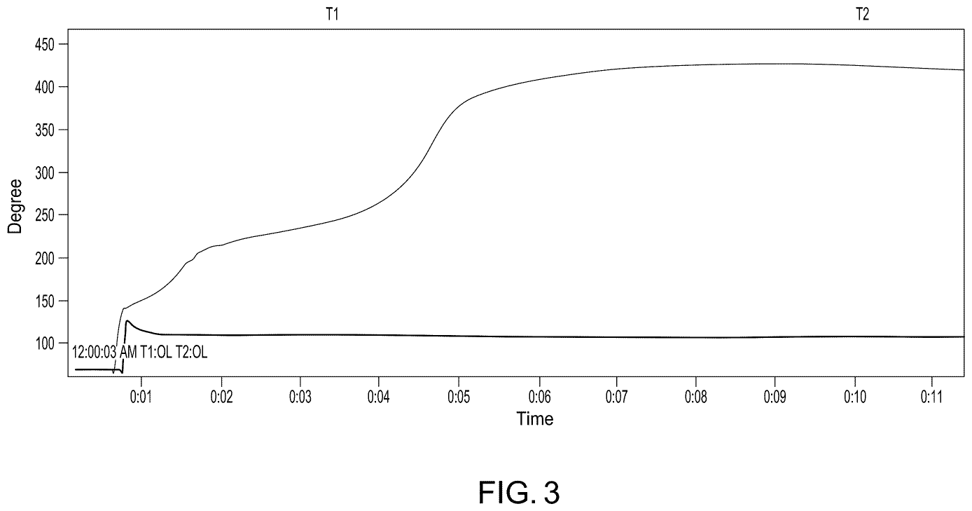

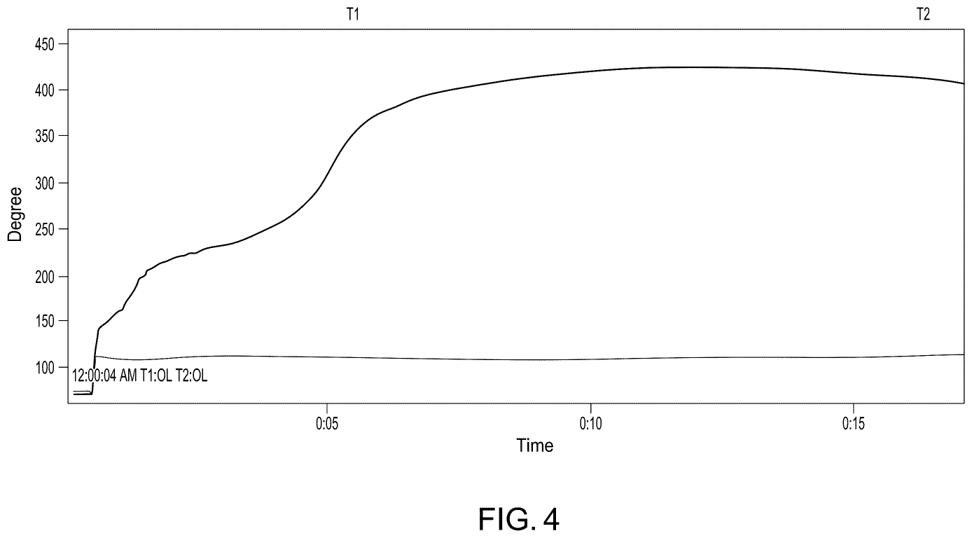

FIG. 3 and FIG. 4 show graphs depicting the increase in temperature over time of Examples 50-2″ and 53-14, respectively.

TABLE 1E

| | 50-2″ | 53-14 |
|---|---|---|
| Part A | | |
| YDCN 500-80 P | 20.25 | 17.85 |
| YDF-170 | 30.38 | 26.8 |
| GE-60 | 9.45 | 8.33 |
| YDM 441 | 12.15 | 10.71 |
| Toyal 101 | 0 | 11.9 |
| S60HS | 4.05 | 3.57 |
| Part B | | |
| NMA | 11.48 | 10.11 |
| Phosphoric acid 85% | 11.48 | 10.11 |
| Q2 Calcium carbonate | .38 | .33 |
| S60HS | .28 | .25 |
| Total | 100 | 100 |

### Example 1F

Example 1F demonstrates the effect of incorporating a catalyst into the formulation with the objective of producing a more complete cure throughout the entire object.

Formulations in Example 1F are conditioned to 43 °C and dispensed from 200 ml cartridges into 400 ml HDPE beakers to a height of about 5 cm.

It is possible that lower temperatures at the corners of molded samples may occur because of heat losses to the environment. The temperatures at these locations may be insufficient to initiate or complete the secondary reaction.

The incorporation of a phosphonium ionic liquid catalyst (Solvay Cyphos IL 169) provides a more thorough cure at the corners of molded samples. Phosphonium catalysts may reduce the activation temperature of reaction between epoxies and anhydrides. The catalyst may also increase the core peak exotherm temperature which is the temperature in the middle of the object determined by placing a thermocouple in the center after the materials has been dispensed. Table 1F shows the different core temperatures between a system with and a system without the catalyst.

Component amounts in the formulations are given as weight percentages in Table 1F.

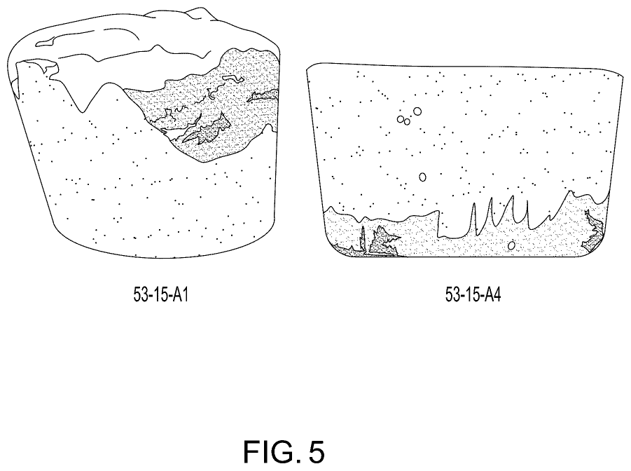

An example of composites formed with and without a phosphonium ionic liquid catalyst can be seen in FIG. 5. Formula 53-15A1 without catalyst is very soft at the edges of the object and uncured material can easily be removed with a spatula. Formula 53-15A4 that contains the catalyst is fully cured throughout its entire volume.

TABLE 1F

| Material | 53-15A1 | 53-15A4 |
|---|---|---|
| Part A | | |
| YDCN 500-80P | 17.29 | 16.60 |
| YDF 170 | 25.94 | 24.91 |
| YDM 441 | 10.38 | 9.96 |
| GE 60 | 8.07 | 7.75 |
| Toyal SP 75-100 | 11.53 | 11.07 |
| Cyphos IL 169 | 0 | 3.03 |
| S60H | 5.76 | 5.53 |
| Part B | | |
| Q2 | 0.32 | 0.32 |
| Phosphoric Acid (85%) | 9.48 | 9.54 |
| NMA | 9.48 | 9.54 |
| S60HS | 1.74 | 1.75 |
| Total | 100.00 | 100.00 |
| Acid/Epoxy (eq.) | 1.06 | 1.11 |
| Epoxy functionality | 3.93 | 3.93 |
| Peak core temperature (°F) | 284 | 331 |
| Cured corners | No | yes |

### Example 1G

Multi-functional phosphate ester curatives like those that are reaction products of phosphoric acid with epoxidized neopentyl glycol (for example Erisys GE-20) with a theoretical acid functionality of four and epoxidized trimethylolpropane (for example Erisys GE 30) with a theoretical acid functionality of six have also demonstrated the ability to increase the Tg compared to systems using a lower average functionality epoxidized phenol-based phosphate ester (for example Erisys GE 13) with a theoretical acid functionality of two. Tg was measured using a TA instruments Q 800 DMA.

The formulations in Example 1G are prepared the same as those in Example 1A. Component amounts in the formulations are given as weight percentages in Table 1G.

TABLE 1G

| | 44-1 | 44-2 | 44-3 |
|---|---|---|---|
| Part A | | | |
| YDF 170 | 31.20 | 31.20 | 31.20 |
| YDCN 500-80P | 31.20 | 31.20 | 31.20 |
| GE 60 | 10.50 | 10.50 | 10.50 |
| YDM 441 | 4.60 | 4.60 | 4.60 |
| Part B | | | |
| PE13 | 7.50 | | |
| PE20 | | 7.50 | |
| PE30 | | | 7.50 |
| Phosphoric acid | 7.50 | 7.50 | 7.50 |
| (85%) | | | |
| NMA | 7.50 | 7.50 | 7.50 |
| Total | 100.00 | 100.00 | 100.00 |
| Tg | 116.7 | 122.6 | 130.7 |

### Example 1H

Example 1H demonstrates the benefit of incorporating foaming ability into the formulation. The formulations in Example 1H (see Table 1H below) are prepared the same as those in Example 1A.

Low density compositions may be desirable for tooling board applications to aid in the speed and quality of machining, and for density reduction for easier handling of larger volumes. Tooling boards typically incorporate hollow glass spheres to reduce density. Expansion can also be produced by incorporation of thermoplastic expanding microspheres (for example Nouryon Expancel). Chemical blowing agents or reaction of the part B acid composition with a metal carbonate are also potential strategies for foaming, all of which may result in lower densities.

Table 1H includes a formulation (sample KE) with a theoretical cured density of 1.09 g/cc but with the incorporation of expanding microspheres (Expancel 951 DU 120) to the formulation (sample JK), has a measured density of 0.75 g/cc as measured by hydrostatic weighing.

TABLE 1H

| | JK | KE |
|---|---|---|
| Part A | | |
| YDCN 500-80P | 15.17 | 15.17 |
| YDCN 631 | 28.55 | 28.55 |
| Kane Ace MX-267 | 11.38 | 11.38 |
| Expancel 951 DU 120 | 0.83 | 0 |
| Byk W 996 | 0.16 | 0.16 |
| Toyal aluminum SP 75-100 | 14.60 | 14.60 |
| KDS 8805 | 10.31 | 10.31 |
| Aerosil R-208 | 0.40 | 0.40 |
| K20 microspheres | 2.34 | 2.34 |
| Part B | | |
| NMA | 6.40 | 6.40 |
| Phosphoric Acid (85%) | 8.17 | 8.17 |
| K20 microspheres | 1.58 | 1.58 |
| Byk W 996 | 0.01 | 0.01 |
| Garamite 1958 | 0.06 | 0.06 |
| Pripol 1013 | 0.16 | 0.16 |
| Total | 100.00 | 99.17 |
| Theoretical density (g/cc) | 1.09 | 1.09 |
| Measured density (g/cc) | .75 | 1.05 |

### Example 2 (Epoxy+Amine/Epoxy+Latent Amine)

The formulations in Example 2 demonstrate another chemistry involving multistage curing that can be used to drive the exotherm to a higher level than that that can be achieved by a single curative. In this example, epoxy resins are cured with a combination of ambient-temperature reactive amine and latent amine. The mixture is formulated so that the exotherm from the ambient temperature amine-epoxy reaction is sufficient to drive the composition temperature to a point at which the latent amine-epoxy reacts significantly. The exotherm from this second reaction increases the mixture temperature enabling a higher Tg composition.

Formulations in Example 2 are prepared by mixing the respective epoxy (A) and amine (B) parts in a speed mixer followed by mixing A and B together in a speed mixer for 15 seconds at 3500 rpm.

Component amounts in the formulation are given in weight percentages in Table 2 along with the acid to epoxy stoichiometry, the maximum exotherm, and associated Tg measured using a TA instruments Q 800 DMA. The amine (Ancamine® 1644) provides a high enough exotherm to allow the dicyanamide (Dicyanex® 1200) to continue to react. The use of both amine and dicyanamide curatives provides a higher exotherm and Tg than the use of the amine alone.

TABLE 2

| | E | F | G |
|---|---|---|---|
| Part A | | | |
| YDPN 631 | 116.00 | 116.00 | 82.80 |
| Total A | 116.00 | 116.00 | 82.80 |
| Part B | | | |
| SP-AD0052 | 3 | 0 | 0 |
| Ancamine ® 1644 | 40.00 | 40.00 | 72.00 |
| Dicyanex ® 1200 | 9.00 | 0.00 | 0 |
| Total B | 49.00 | 40.00 | 72.00 |
| Total A + B | 165.00 | 156.00 | 154.8 |
| Amine hydrogen/Epoxy | 1.04 | 0.26 | 1.00 |
| Stoichiometry | | | |
| Maximum exotherm (°F) | 420 | 260 | 349 |
| Tg (°C tan delta, DMA) | 102 | 77 | 74 |

### Example 3—(Epoxy+Acidic Phosphorous/Acrylic)

Example 3A illustrates the use of the exothermic reaction between an acidic phosphorous material and an epoxide triggering thermal decomposition of a peroxide to cure a high Tg (meth)acrylate or (meth)acrylate blend. Additionally, the use of HEMA phosphate in the formulation demonstrates the use of a component that participates in more than one exothermic reaction.

YDCN-500-80P is pre-dissolved in a blend of YDPN-631 and Kane Ace MX267 in the ratio described in Table 3A. One part 4-Hydroxy TEMPO is dissolved in 99 parts YDPN-631 by heating the 4-Hydroxy TEMPO past its melting point and subsequently speed mixing the heated material. The formulation as described in Table 3A is mixed under vacuum in a speed mixer. Part A, as described in Table 3A is used to fill the more voluminous side of 2:1 volumetric cartridges and Part B is used to fill the adjacent side. The two components are dispensed through a 10-24 helical static mixer at 30 °C into an aluminum foil lined, 1 L (10 cm×10 cm×10 cm) rockwool-insulated mold and allowed to cure.

TABLE 3A

| | |
|---|---|
| YDPN-631 | 30 |
| YDCN-500-80P | 10 |
| YDM 441 | 3 |
| 1% Hydroxy Tempo in YDPN-631 | 5 |
| Kane Ace MX-267 | 10 |
| Specialty Minerals Ultra Pflex | 2 |
| TBPB (Luperox P) | 0.2 |
| IBOMA | 10 |
| Miwon M370 | 17.9 |
| 3M K-20 Bubbles | 10 |
| Luperox 231XL 40 | 0.2 |
| Water | 0.3 |
| Aerosil 200 | 1.4 |
| Total Percent Part A | 100 |
| HEMA Phosphate Ester | 42 |
| Miwon M-370 | 12 |
| Methacrylic Acid | 10 |
| Nadic Methyl Anhydride | 10 |
| Nyagraph 35 | 15 |
| K20 microspheres | 10 |
| Aerosil R-208 | 1 |
| Total Percent Part B | 100 |
| Peak temperature at center (°C) | 182 |
| Cured Density | 0.74 |
| Tg at center (onset, °C) | 138 |
| Tg at center (tan delta peak, °C) | 177 |

The peak exotherm of the resulting mixture is 360 °F at the center of the block. This temperature is in substantial excess of the 1-hour half-life of both Luperox P (257.6 °F) and 231XL40 (230 °F). The free radical generated by thermally decomposing the peroxides polymerizes the available (meth)acrylate unsaturation. This is evident in the Tg by DMA of the sample having an onset Tg of 138 °C and Tan Delta of 177 °C.

### Example 4, (Acrylic+Acrylic+Epoxy-Anhydride)

Example 4 illustrates the use of a room temperature initiated (meth)acrylate polymerization to initiate a latent peroxide and epoxy-anhydride polymerization.

One part 4-Hydroxy TEMPO is dissolved in 99 parts YDPN-631 by heating the 4-Hydroxy TEMPO past its melting point and subsequently speed mixing the heated material. One part ferrocene is dissolved into Miramer M-370 via speed mixing. The formulations are mixed and degassed with a speed mixer in accordance with Table 4 below. The formulations are then used to fill 400 mL 2:1 cartridges with the proper volumetric mix of 2:1 Part B: Part A. The material is dispensed at 88 °F through a 10-24 helical static mixer into a 20 cm×20 cm×10 cm galvanized steel mold set into rockwool insulation.

TABLE 4

| Part A | |
|---|---|
| YDPN-631 | 20 |
| Syna Epoxy 21 | 46.1 |
| 1% Hydroxy Tempo in YDPN-631 | 5 |
| Kane Ace MX267 | 10 |
| Luperox P | 0.5 |
| K20 microspheres | 15 |
| Benox B-50 | 2 |
| Aerosil R-208 | 1 |
| Total Percent Part A | 99.6 |
| Part B | |
| Miwon M-370 | 55 |
| Methacrylic Acid | 5 |
| Nadic Methyl Anhydride | 22 |
| K-20 Bubbles | 15 |
| 1% Ferrocene in M370 | 2 |
| Aerosil R-208 | 1 |
| Total Percent Part B | 100 |
| Peak Temperature at center (°C) | 229 |
| Tg at center (onset, °C) | 162 |
| Tg at center (tan delta peak, °C) | 201 |

In Example 4, ferrocene is utilized to catalyze the decomposition of benzoyl peroxide at ambient temperature, initiating polymerization of the (meth)acrylate blend. 4-hydroxy TEMPO is used to mediate this reaction and extend the working time. The resulting material had a peak exotherm of 229 °C, substantially higher than the decomposition temperature of the Luperox P as described in Example 3, as well as beyond the initiation temperature for epoxy-anhydride polymerization described in earlier examples. The resulting polymer did not exhibit any signs of charring due to the exotherm. Said composite material had an Onset Tg of 162 °C and Tan Dela Tg of 201 °C.

### Example 5—Epoxy Homopolymerization/Epoxy-Anhydride

In Example 5, a high Tg composition arises from sufficient catalysis of epoxy homopolymerization to slowly increase the temperature to a point where epoxy-anhydride reaction occurs. Component amounts in the formulation are given in weight per hundred resin in Table 5.

TABLE 5

| | XX-3 |
|---|---|
| YD 128 | 70 |
| Araldite MY 721 | 30 |
| Cardolite NT 1300 | 5 |
| Aradur HY-918 | 96 |
| Q-cell 7023S microspheres | 50 |

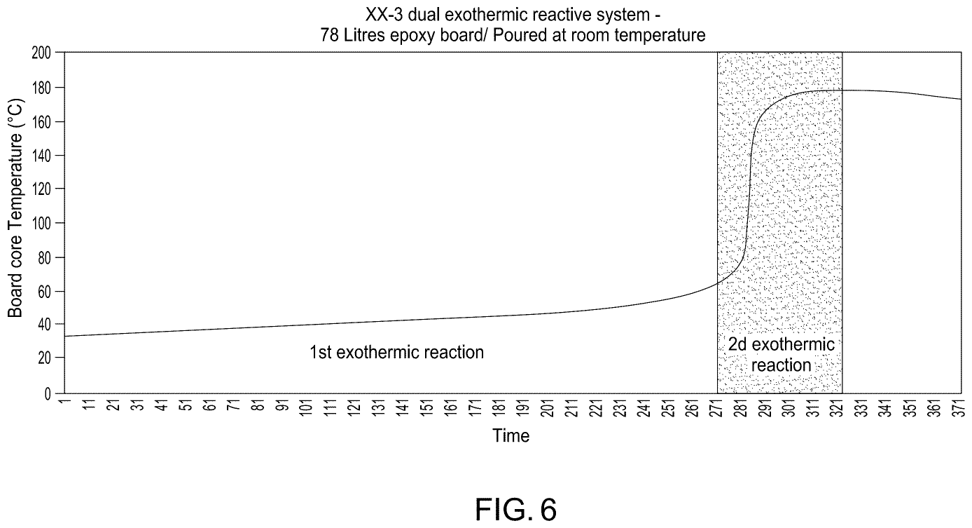

FIG. 6 shows the temperature tracking of a 78-liter board made with XX-3 formulation. Some inert hollow glass microspheres are used to decrease the density of the board. All ingredients are mixed under vacuum into a Farfly planetary mixer for 30 minutes and then casted at 30 °C into an uninsulated metal mold at ambient temperature to form a 960×480×170 mm board.

The material temperature ramp up is measured with a probe in the core of the board. The first reaction temperature ramp up is approximately 0.08 °C/min, the subsequent reaction has an onset temperature at 65 °C, ramp up of 11.4 °C/min. The maximum temperature recorded was 178 °C. The resulting composite material has an onset Tg of 140 °C and tan delta Tg of 160 °C measured with a Metravib DMA.

It is understood that the above description is intended to be illustrative and not restrictive. Many embodiments as well as many applications besides the examples provided will be apparent to those of skill in the art upon reading the above description. The scope of the invention should, therefore, be determined not with reference to the above description, but should instead be determined with reference to the appended claims, along with the full scope of equivalents to which such claims are entitled. The disclosures of all articles and references, including patent applications and publications, are incorporated by reference for all purposes. The omission in the following claims of any aspect of subject matter that is disclosed herein is not a disclaimer of such subject matter, nor should it be regarded that the inventors did not consider such subject matter to be part of the disclosed inventive subject matter.

The explanations and illustrations presented herein are intended to acquaint others skilled in the art with the invention, its principles, and its practical application. The above description is intended to be illustrative and not restrictive. Those skilled in the art may adapt and apply the invention in its numerous forms, as may be best suited to the requirements of a particular use.

Accordingly, the specific embodiments of the present invention as set forth are not intended as being exhaustive or limiting of the teachings. The scope of the teachings should, therefore, be determined not with reference to this description, but should instead be determined with reference to the appended claims, along with the full scope of equivalents to which such claims are entitled. The omission in the following claims of any aspect of subject matter that is disclosed herein is not a disclaimer of such subject matter, nor should it be regarded that the inventors did not consider such subject matter to be part of the disclosed inventive subject matter.

Plural elements or steps can be provided by a single integrated element or step. Alternatively, a single element or step might be divided into separate plural elements or steps.

The disclosure of “a” or “one” to describe an element or step is not intended to foreclose additional elements or steps.

The terms “generally” or “substantially” to describe angular measurements may mean about +/−10° or less, about +/−5° or less, or even about +/−1° or less. The terms “generally” or “substantially” to describe angular measurements may mean about +/−0.01° or greater, about +/−0.1° or greater, or even about +/−0.5° or greater. The terms “generally” or “substantially” to describe linear measurements, percentages, or ratios may mean about +/−10% or less, about +/−5% or less, or even about +/−1% or less. The terms “generally” or “substantially” to describe linear measurements, percentages, or ratios may mean about +/−0.01% or greater, about +/−0.1% or greater, or even about +/−0.5% or greater.

Unless otherwise stated, all ranges include both endpoints and all numbers between the endpoints. The use of “about” or “approximately” in connection with a range applies to both ends of the range. Thus, “about 20 to 30” is intended to cover “about 20 to about 30”, inclusive of at least the specified endpoints.

Unless otherwise stated, any numerical values recited herein include all values from the lower value to the upper value in increments of one unit provided that there is a separation of at least 2 units between any lower value and any higher value. As an example, if it is stated that the amount of a component, a property, or a value of a process variable such as, for example, temperature, pressure, time, and the like is, for example, from 1 to 90, from 20 to 80, or from 30 to 70, it is intended that intermediate range values such as (for example, 15 to 85, 22 to 68, 43 to 51, 30 to 32, etc.) are within the teachings of this specification. Likewise, individual intermediate values are also within the present teachings. For values which are less than one, one unit is considered to be 0.0001, 0.001, 0.01, or 0.1 as appropriate. These are only examples of what is specifically intended and all possible combinations of numerical values between the lowest value and the highest value enumerated are to be considered to be expressly stated in this application in a similar manner. Unless otherwise stated, all ranges include both endpoints and all numbers between the endpoints.

As can be seen, the teaching of amounts expressed as “parts by weight” herein also contemplates the same ranges expressed in terms of percent by weight. Thus, an expression in the of a range in terms of “at least ‘x’ parts by weight of the resulting composition” also contemplates a teaching of ranges of same recited amount of “x” in percent by weight of the resulting composition.

The term “consisting essentially of” to describe a combination shall include the elements, ingredients, components, or steps identified, and such other elements ingredients, components or steps that do not materially affect the basic and novel characteristics of the combination. The use of the terms “comprising” or “including” to describe combinations of elements, ingredients, components, or steps herein also contemplates embodiments that consist essentially of the elements, ingredients, components, or steps. The terms “including” and “comprising” may be used interchangeably.

The disclosures of all articles and references, including patent applications and publications, are incorporated by reference for all purposes. Other combinations are also possible as will be gleaned from the following claims, which are also hereby incorporated by reference into this written description.

1. A polymeric composition comprising:
a part A comprising at least 20% by weight of a first epoxy resin; and
a part B comprising an acidic phosphorous component adapted to react with part A;
wherein upon contacting part A and part B, heat is generated from a first exothermic reaction which increases the composition temperature to a temperature sufficiently high to cause a second exothermic reaction.

2. The composition of claim 1, where the first exothermic reaction is initiated at temperatures less than 40 °C.

3. The composition of claim 1, wherein a peak temperature of the composition is greater than 100 °C.

4. The composition of claim 2, wherein the composition has a glass transition temperature (Tg) of about 100 °C or greater.

5. The composition of claim 4, including a reinforcing component.

6. The composition of claim 5, including a thermally conductive material.

7. The composition of claim 5, including a component comprising hollow spheres.

8. The composition of claim 1, wherein part A, part B, or both includes one or more thermally induced phase changing materials.

9. The composition of claim 5, wherein part A, part B, or both include a physical blowing agent, a chemical blowing agent or a combination thereof.

10. (canceled)

11. (canceled)

12. The composition of claim 1, wherein the one or more toughening agents include one or more core-shell particulate toughening agents.

13. The composition of claim 12, wherein the composition includes one or more rheological control agents.

14. (canceled)

15. The composition of claim 1, wherein the composition includes one or more carboxylic acid cyclic anhydrides.

16. (canceled)

17. The composition of claim 15, wherein part A, part B, or both includes one or more catalysts for causing a reaction between an epoxy and a carboxylic acid cyclic anhydride.

18. The composition of claim 1, wherein the composition includes one or more (meth)acrylate monomers and/or one or more (meth)acrylic functional resins.

19. The composition of claim 1, wherein part A, part B, or both include one or more peroxides.

20. The composition of claim 19, wherein part A, part B, or both include one or more peroxide decomposition accelerators.

21. (canceled)

22. The composition of claim 5, wherein part A, part B, or both include one or more isocyanate resins.

23. The composition of any of claim 22, wherein part A, part B, or both include one or more resins that are reactive with isocyanates.

24. The composition of claim 1, wherein part A, part B, or both include one or more amine resins.

25. (canceled)

26. The composition of claim 1, wherein part A, part B, or both include one or more ring-strained components adapted for exothermic ring-opening reactions.

27-43. (canceled)
